(19) United States
(12) Patent Application Publication
(10) Pub. No.: US 2009/0043855 A1
(43) Pub. Date: Feb. 12, 2009

(54) SYSTEM FOR PROVIDING INFORMATION TO ORIGINATOR OF MISDIRECTED EMAIL

(76) Inventors: Blake Bookstaff, Knoxville, TN (US); Vincent Claude, Apopka, FL (US)

Correspondence Address: LUEDEKA, NEELY & GRAHAM, P.C., P O BOX 1871, KNOXVILLE, TN, 37901, US

(21) Appl. No.: 11/835,537

(22) Filed: Aug. 8, 2007

(51) Int. Cl. G06F 15/16

(52) U.S. Cl. 709/206

(57) ABSTRACT

The invention provides a computer-implemented method for responding to an email message sent by a sender to an intended recipient. The method includes the steps of extracting the recipient email address from the initial email message and determining whether there exists a valid email account corresponding to the extracted recipient email address. When it is determined that no valid email account exists corresponding to the recipient email address, a response email message is generated and directed to the sender email address. The response email message not only indicates that the initial email message was undeliverable, but it includes supplemental information that may be of use to the sender. For example, the supplemental information may include advertisement information or search links that may or may not be contextually relevant to the content of the initial email.

### FIELD

This invention relates to the field of electronic mail. More particularly, this invention relates to a system for responding to senders of undeliverable email messages.

### BACKGROUND

In most cases, when an email message is undeliverable, the sender of the undeliverable email receives a message informing the sender that the message could not be delivered. Typically, this message includes a brief and often cryptic statement of the reason why the message could not be delivered. In many cases, email messages cannot be delivered because the recipient address was misspelled, the recipient's email account has been discontinued, or the recipient address is not associated with a valid account.

There have been no means in the past of providing any further helpful information to the sender of an undeliverable email message. What is needed, therefore, is a system that responds to a sender of an undeliverable email message, where the response includes information regarding the intended recipient, information regarding the subject matter of the message and/or other information that the sender may find helpful.

### SUMMARY

The above and other needs are met by a computer-implemented method for responding to an initial email message sent by a sender to an intended recipient. The method includes the steps of extracting the recipient email address from the initial email message and determining whether there exists a valid email account corresponding to the extracted recipient email address. When it is determined that no valid email account exists corresponding to the recipient email address, a response email message is generated and directed to the sender email address. The response email message not only indicates that the initial email message was undeliverable, but it includes supplemental information that may be of use to the sender. For example, the supplemental information may include advertisement information or search links that may or may not be contextually relevant to the content of the initial email.

In some preferred embodiments, the step of determining whether a valid email account exists comprises determining: (1) whether a domain name in the recipient email address exists in a Domain Name Server database; (2) whether a mail exchange record exists for a domain name in the recipient email address; or (3) whether a username in the recipient email address is valid.

The method may include searching for keywords in the content of the initial email message and composing the supplemental information in the response message to include advertising information that is related to one or more keywords found in the initial email message.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a functional block diagram of an email delivery system according to a preferred embodiment of the invention; and

FIG. 2 depicts a method for delivering an email message according to a preferred embodiment of the invention.

### DETAILED DESCRIPTION

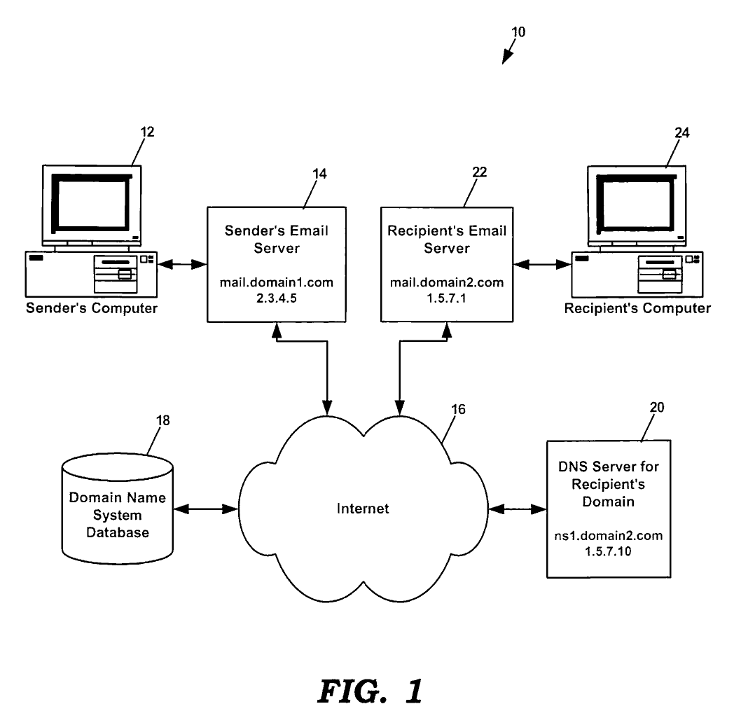

Before describing preferred embodiments of the present invention, a typical email delivery operation will be described wherein an email message from a sender is successfully delivered to a recipient. This operation may occur within the email delivery system 10 depicted in FIG. 1, which includes a sender computer 12, a sender email server 14, a Domain Name System (DNS) database 18, a DNS server for the recipient domain 20, a recipient email server 22 and a recipient computer 24. The sender email server 14, the recipient email server 22, the DNS database 18 and the DNS server 20 are operable to communicate with each other via a communication network 16 such as the Internet.

With reference to FIG. 1, an email message is composed on the sender's computer 12 using an email program, such as Eudora (from Qualcomm), Thunderbird (from Mozilla) or Microsoft Outlook. For purposes of the examples presented here, the sender email address is “fred@domain1.com” and the recipient email address is “barney@domain2.com”. The message is initially sent using Simple Mail Transfer Protocol (SMTP) from the sender computer 12 to the sender email server 14. In the example of FIG. 1, the sender email server 14 has a network name of “mail.domain1.com” and an address of “2.3.4.5”. The sender email server 14 may also be referred to as a local Mail Transfer Agent (MTA) and may be operated by the sender's local Internet Service Provider (ISP).

Software running on the sender email server 14 determines the destination address of the message, which in this example is “barney@domain2.com.” The sender email server 14 then initiates a query of the Domain Name System (DNS) database 18 to look up the network address of the DNS server 20 for the recipient domain name “domain2.com.” For example, the network name of the DNS server 20 may be “ns1.domain2.com” and its address may be “1.5.7.10”, as shown in FIG. 1. The sender email server 14 then sends a request to “ns1.domain2.com” at address “1.5.7.10” for a Mail Exchange (MX) record which lists all mail exchange servers that are accepting messages for the “domain2.com” domain. If an MX record exists, the DNS server 20 responds by sending the address (e.g. “1.5.7.1”) to the sender email server 14.

In the present example, the returned MX record lists “mail.domain2.com” as the name with the network address of “1.5.7.1” for the recipient email server 22, which may be a mail exchange server operated by the recipient's ISP. Using SMTP, the sender email server 14 then sends the email message to the recipient email server 22 named “mail.domain2.com” at address “1.5.7.1”. The recipient email server 22 places the message in a mailbox associated with the username “barney.” The message then can be downloaded from the server 22 to the recipient computer 24.

The previous example illustrates how the email process may work if there are no errors in the recipient email address. However, if errors are present, the email message may be undeliverable. Errors in the recipient email address may include (1) a misspelled or nonexistent username (“barney” in the previous example), (2) a misspelled or nonexistent domain name (“domain2”) or (3) a misspelled or nonexistent top level domain (“.com”). In some instances, delivery errors also occur when (4) no MX record exists for a particular domain.

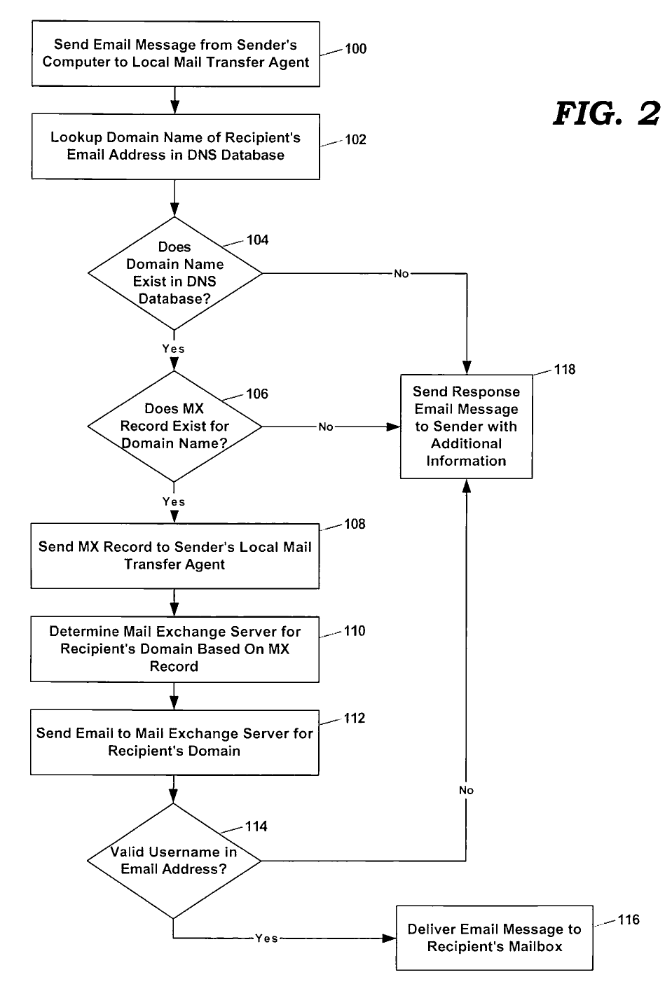

With reference to FIGS. 1 and 2, the following examples illustrate how a preferred embodiment of the present invention handles various errors in the delivery of an email message. In each example, the sender email address is again “fred@domain1.com.” In a first example, when an email message is composed on the sender computer 12, the recipient email address is mistakenly entered as “berney@domain2.com” instead of “barney@domain2.com.” The message is sent from the sender computer 12 to the local MTA on the sender email server 14 (step 100). The MTA of the sender email server 14 queries the DNS database 18 for the network address of the DNS server 20 for the recipient domain name (domain2.com) (step 102). Based on the reply from the DNS database 18, the sender email server 14 determines whether the queried domain name exists in the DNS database 18 (step 104). In this example, the domain name (domain2.com) does exist and the network address of the DNS server 20 (ns1@domain2.com) is returned.

The sender email server 14 then requests from the DNS server 20 an MX record which lists all mail exchange servers that are accepting messages for the domain of the email recipient (domain2.com). Based on the reply from the DNS server 20, the sender email server 14 determines whether an MX record exists for “domain2.com.” (step 106). In this example, an MX record does exist, and the DNS server 20 responds by sending the MX record to the sender email server 14 (step 108). The sender email server 14 then determines the address of the recipient mail exchange server 22 (mail.domain2.com with the address “1.5.7.1”) as listed in the received MX record (step 110). The email message is then sent from the sender email server 14 via the Internet 16 to the address of the recipient email server 22 (step 112).

The recipient email server 22 looks at the username (berney) in the received email address and determines whether a corresponding username exists for any user registered with the server 22 (step 114). In this example, there is no “berney” registered as a valid username on the server 22. When no valid username exists for a recipient of an incoming email message, the recipient email server 22 generates a response email message with supplemental information directed to the email address of the sender (step 118.)

In a preferred embodiment of the invention, the response email message includes a message such as, “Sorry, you sent this message to an invalid email address. There is no username “berney” registered on our email server.” The response message also preferably includes a copy of at least a portion of the text of the original (undeliverable) message, and some type of advertisement information or search links that may or may not be contextually relevant to the content of the original email.

In some embodiments, the response message also provides a list of valid usernames that are close in spelling to the username of the recipient address of the undeliverable message. For example, the response message may include a message such as, “Did you mean to send your message to any of the following usernames: barney, burns, bernard?”

In some embodiments of the invention, prior to sending the response message, the text of the original message is examined by a search engine to find keywords that may be indicative of some interest of the sender. These keywords may then be used to determine what supplemental information is to be included in the response message. For example, if the word “garden” or “gardening” is detected in the original message, the response message may include links to gardening-related websites or websites at which gardening supplies are sold.

In some embodiments, the sender email address associated with every undeliverable incoming message is logged and used for marketing purposes. These addresses may also be placed in various categories based on keywords in the recipient address or in the text of the incoming message. For example, the sender address associated with a message directed to “info@gardensupply.com” may be categorized under gardening interests.

In a second example of a misdirected email message, when the message is composed on the sender computer 12, the recipient email address is mistakenly entered as “barney@domaintoo.com” instead of “barney@domain2.com.” The message is sent from the sender computer 12 to the local MTA on the sender email server 14 (step 100). The MTA of the sender email server 14 queries the DNS database 18 for the network address of the DNS server 20 for the recipient domain name (domaintoo.com) (step 102). Based on the reply from the DNS database 18, the sender email server 14 determines whether the queried domain name exists in the DNS database 18 (step 104). In this example, the query of the DNS database 18 for “domaintoo.com” returns no results which indicates that this domain does not exist in the database 18.

In this situation, the sender email server 14 places a response email message in the incoming mail mailbox associated with the sender of the original message (step 11 8). In a preferred embodiment of the invention, this response email message includes a message such as “Sorry, you sent this message to an invalid email address. There is no domain name ‘domaintoo’ in the Domain Name System database.” As with the response message generated by the recipient email server, this response message also preferably includes a copy of the text of the original message and some type of advertisement information or search links that may be contextually relevant to the content of the original email.

In some embodiments, the response message also provides a list of valid domain names that are close in spelling to the domain name of the recipient address of the undeliverable message. For example, the response message may include a message such as, “Did you mean to send your message to any of the following domains: domain2, domaintwo, domaintu?”

In a third example of a misdirected email message, when the message is composed on the sender computer 12, the recipient email address is incorrectly entered as “barney@domain3.com” instead of “barney@domain2.com.” The message is sent from the sender computer 12 to the local MTA on the sender email server 14 (step 100). The MTA of the sender email server 14 queries the DNS database 18 for the network address of the DNS server 20 for the recipient domain name (domain3.com) (step 102). Based on the reply from the DNS database 18, the sender email server 14 determines whether the queried domain name exists in the DNS database 18 (step 104). In this example, the domain name (domain3.com) does exist and the network address of the DNS server 20 (ns1@domain3.com at address “7.3.2.1”) is returned.

In this example, although the domain exists, no MX record has been activated for “domain3.com.” Thus, when the sender email server 14 requests an MX record from the DNS server 20, the DNS server 20 sends an error message or other reply indicating that no MX record exists for “domain3.com” (step 106). In this situation, the sender email server 14 places a response email message in the incoming mail mailbox associated with the sender of the original message (step 118). In a preferred embodiment, this response email message includes a message such as “Sorry, you sent this message to an invalid email address. The domain ‘domain3’ has not been activated to receive incoming email messages.” As with the response message generated in the previous examples, this response message may also include a copy of the text of the original message and some type of advertisement information or search links that may be contextually relevant to the content of the original email.

In another scenario associated with this example, the domain “domain3.com” exists and an MX record for domain3.com has been activated. In this scenario, however, the MX record has been for the sole purpose of responding to misdirected emails that include the “domain3.com” domain. In other words, there are no email usernames registered for this domain. In this situation, when the sender email server 14 requests an MX record from the DNS server 20 for the domain3.com domain, the DNS server 20 sends the address of the mail server that would then send a response message or other reply indicating that the intended recipient username does not exist on “domain3.com”. In a preferred embodiment, this response email message from domain3.com includes a message such as “Sorry, you sent this message to an invalid email address. There is no username “barney” registered on our email server.” This response message also preferably includes a copy of the text of the original message and some type of advertisement information or search links that may be contextually relevant to the content of the original email.

It should be appreciated that the invention is not limited to generation of a response message by any particular computer or server in the email delivery chain. For example, the response message in the first scenario above may be generated by the sender email server 14 instead of the recipient email server 22. Alternatively, the response messages in any of the example scenarios may be generated by a dedicated server connected to the Internet whose sole function is to generate response messages when it is determined that an email message is undeliverable. This dedicated server may be activated to send the response message to the sender address based on information provided by the sender email server 14 or the recipient email server 22 associated with the recipient address.

The foregoing description of preferred embodiments for this invention have been presented for purposes of illustration and description. They are not intended to be exhaustive or to limit the invention to the precise form disclosed. Obvious modifications or variations are possible in light of the above examples. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A computer-implemented method for responding to an initial email message sent from a sender email address and directed to a second email address, the method comprising:
(a) extracting the second email address from the initial email message;
(b) determining that no valid email account exists corresponding to the second email address extracted from the initial email message; and
(c) generating a response email message directed to the sender email address, wherein the response email message includes supplemental information and information indicating that the initial email message was not delivered to the second email address.

2. The method of claim 1 wherein step (c) includes generating the response email message including supplemental information comprising advertising information.

3. The method of claim 1 wherein step (c) includes generating the response email message including supplemental information comprising a Uniform Resource Locator (URL) pointing to a web page that is accessible via a global communication network.

4. The method of claim 1 wherein step (b) comprises determining whether a domain name in the second email address exists in a Domain Name Server database.

5. The method of claim 1 wherein step (b) comprises determining whether a mail exchange record exists for a domain name in the second email address.

6. The method of claim 1 wherein step (b) comprises determining whether a username in the second email address is valid.

7. The method of claim 1 wherein step (c) comprises generating the response email message at a server computer selected from the group consisting of a sender email server, a recipient email server and a domain name server.

8. The method of claim 1 wherein step (b) comprises accessing a mail exchange record which provides a listing of one or more email servers associated with the second email address, and directing the initial email message to one or more of the email servers listed in the mail exchange record; and
step (c) comprises generating the response email message at the one or more email servers to which the initial email message was directed.

9. The method of claim 1 further comprising recording the sender email address in a log.

10. The method of claim 1 wherein step (c) further comprises:
(c1) searching for keywords in the subject matter of the initial email message; and
(c2) generating the supplemental information to include information that is related to one or more keywords found in the subject matter of the initial email message.

11. A computer-implemented method for responding to an initial email message sent from a sender email address and directed to a second email address, the method comprising:
(a) extracting the second email address from the initial email message;
(b) determining whether there exists a valid email account corresponding to the second email address extracted from the initial email message, wherein the determining includes one or more of:
(b1) determining whether a domain name in the second email address exists in a Domain Name Server database;
(b2) determining whether a mail exchange record exists for a domain name in the second email address; and
(b3) determining whether a usemame in the second email address is valid; and
(c) generating a response email message directed to the sender email address, wherein the response email message includes advertising information and information indicating that the initial email message was not delivered to the second email address, wherein generation of the response email message includes:
(c1) searching for keywords in the subject matter of the initial email message; and
(c2) generating the advertising information to include information that is related to one or more keywords found in the subject matter of the initial email message.

12. The method of claim 10 wherein step (c2) further comprises generating the supplemental information at a server other than a sender email server or a recipient email server.

13. The method of claim 11 wherein step (c) further comprises generating the response email message at a server other than a sender email server or a recipient email server.

14. A computer-implemented method for responding to an initial email message sent from a sender email address and directed to a second email address associated with a domain that is not operable to receive incoming email messages, the method comprising:
(a) prior to the sending of the initial email message, configuring a mail exchange record for the domain associated with the second email address, where the mail exchange record is configured to point to a mail server;
(b) after the sending of the initial email message, determining the domain associated with the second email address;
(c) determining based on the mail exchange record of the domain determined in step (b) that a response to the initial email message is to be generated by the mail server indicated by the mail exchange record;
(d) generating a response email message at the mail server indicated by the mail exchange record, where the response email message is directed to the sender email address and includes:
information indicating that the initial email message was not delivered to the second email address; and
links to supplemental information that may be of interest to a sender of the initial email message, wherein the supplemental information is related to subject matter contained in the initial email message.
